(19) United States
(12) Patent Application Publication
(10) Pub. No.: US 2026/0345429 A1
(43) Pub. Date: Nov. 5, 2026

(54) METHODS AND SYSTEMS FOR PROVIDING AN INTERACTIVE PLATFORM TO FACILITATE AN INTERACTIVE SESSION FOR USERS

(71) Applicant: HYTTO PTE. LTD., Singapore (SG)

(72) Inventors: Jilin Qiu, Singapore (SG); Junjiang Liu, Guangzhou (CN)

(73) Assignee: HYTTO PTE. LTD., Singapore (SG)

(21) Appl. No.: 19/724,836

(22) Filed: Jun. 29, 2026

Related U.S. Application Data
(63) Continuation-in-part of application No. 19/323,359, filed on Sep. 9, 2025.
Application No. 19/323,359 is a continuation-in-part of application No. 19/202,272, filed on May 8, 2025.
Application No. 19/202,272 is a continuation-in-part of application No. 18/806,047, filed on Aug. 15, 2024, now Pat. No. 12,318,340.
Application No. 18/806,047 is a continuation of application No. 18/351,390, filed on Jul. 12, 2023, now Pat. No. 12,539,248.
Application No. 18/351,390 is a continuation of application No. 18/048,817, filed on Oct. 21, 2022, now Pat. No. 11,943,516.
Application No. 18/351,390 is a continuation-in-part of application No. 17/714,278, filed on Apr. 6, 2022, now Pat. No. 11,737,948.
(63) Continuation-in-part of application No. 18/189,172, filed on Mar. 23, 2023.

(51) Int. Cl. A61H 19/00; H04L 67/125; G06Q 10/40; H04L 9/40

(52) U.S. Cl. CPC A61H 19/00; H04L 67/125; G06Q 10/40; H04L 63/0236; H04L 2209/56; H04L 2209/80

(57) ABSTRACT

The present disclosure relates to methods and systems for providing an interactive platform to facilitate an interactive session for users. The method performed by a system includes establishing an interactive session between a plurality of users in an interactive platform. The method includes creating a role pool associated with the interactive session. The role pool includes at least one controlling role and one or more controlled roles. Further, the method includes dividing the interactive session into one or more sub interactive sessions based at least on a set of predetermined rules. The method includes receiving at least one control instruction from the at least one controlling role in the interactive session to operate one of the at least one stimulation device and the set of operative components associated with each of the at least one stimulation device of the one or more controlled roles.

### CROSS REFERENCE TO RELATED APPLICATIONS

This application is a Continuation-in-Part Application of U.S. Application No. 19/323,359, filed Sep. 9, 2025, which is a Continuation-in-Part Application of U.S. Application No. 19/202,272, filed May 8, 2025, which is a Continuation-in-Part Application of U.S. Application No. 18/806,047, filed Aug. 15, 2024, now U.S. Pat. No. 12,318,340, issued on Jun. 3, 2025, which is a Continuation Application of Application No. 18/351,390 filed Jul. 12, 2023, Now U.S. Pat. No. 12,539,248, issued on Feb. 3, 2026, which is a Continuation-in-Part Application of Application No. 17/714,278 filed Apr. 6, 2022, Now U.S. Pat. No. 11,737,948, issued on Aug. 29 2023. This application is also is a Continuation-in-Part Application of U.S. Application No. 18/189,172 filed Mar. 23, 2023.

### TECHNICAL FIELD

The present disclosure relates to an adult entertainment platform, more particularly relates to systems and methods for managing an interactive session related to adult entertainment activities for users.

### BACKGROUND

In recent years, digital platforms supporting adult-oriented interactive content have increasingly incorporated network-connected devices that may be operated remotely by one or more users. Such platforms enable real-time interaction between a content host and remote participants, including the transmission of control signals to stimulation devices associated with the host. Certain platforms support multi-user participation models in which multiple participants may attempt to interact with or influence operation of the same device or related device functions.

Despite these advancements, existing interactive platforms encounter a number of technical limitations. For example, conventional implementations may rely on static pairing arrangements or persistent access mechanisms that do not sufficiently regulate or constrain control privileges once granted. In multi-user environments, managing simultaneous or competing control inputs can introduce complexity in coordination, authority prioritization, and conflict resolution. Additionally, existing systems may lack flexible mechanisms for limiting access duration, conditionally granting or revoking permissions, or ensuring that control privileges are aligned with current participation states. These shortcomings can lead to unintended device operation, difficulty in managing multi-user interaction, and increased exposure to unauthorized or improper access.

Therefore, there is a need for methods and systems to manage multi-user interactive sessions related to adult entertainment activity to overcome the above-mentioned deficiencies, along with providing other technical advantages.

### SUMMARY

Various embodiments of the present disclosure disclose methods and systems for providing an interactive platform to facilitate an interactive session between a host user and a plurality of users.

In an embodiment, a computer-implemented method is disclosed. The computer-implemented method performed by a system includes establishing an interactive session between a plurality of users in an interactive platform. The method includes creating a role pool associated with the interactive session. The role pool includes at least one controlling role and one or more controlled roles. The role pool is created in the interactive session by assigning the at least one controlling role and the one or more controlled roles to a corresponding user of the plurality of users. Further, the method includes dividing the interactive session into one or more sub interactive sessions based at least on a set of predetermined rules. The one or more sub interactive sessions enable the one or more controlling roles to operate one of at least one stimulation device and a set of operative components associated with each of the at least one stimulation device of the one or more controlled roles. Furthermore, the method includes receiving at least one control instruction from the at least one controlling role in the interactive session to operate one of the at least one stimulation device and the set of operative components associated with each of the at least one stimulation device of the one or more controlled roles according to the one or more sub interactive sessions.

In another embodiment, a system is disclosed. The system includes a communication interface, a memory including executable instructions, and a processor communicably coupled to the communication interface and the memory. The system is configured to establish an interactive session between a plurality of users in an interactive platform. The system is caused to create a role pool associated with the interactive session. The role pool includes at least one controlling role and one or more controlled roles. The role pool is created in the interactive session by assigning the at least one controlling role and the one or more controlled roles to a corresponding user of the plurality of users. Further, the system is caused to divide the interactive session into one or more sub interactive sessions based at least on a set of predetermined rules. The one or more sub interactive sessions enable the one or more controlling roles to operate one of at least one stimulation device and a set of operative components associated with each of the at least one stimulation device of the one or more controlled roles. Furthermore, the system is caused to receive at least one control instruction from the at least one controlling role in the interactive session to operate one of the at least one stimulation device and the set of operative components associated with each of the at least one stimulation device of the one or more controlled roles according to the one or more sub interactive sessions.

### BRIEF DESCRIPTION OF THE FIGURES

The following detailed description of illustrative embodiments is better understood when read in conjunction with the appended drawings. For the purposes of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an example representation of an environment related to at least some example embodiments of the present disclosure;

FIG. 2 illustrates a simplified block diagram of a system for managing an interactive session related adult entertainment activity, in accordance with an embodiment of the present disclosure;

FIGS. 3A, 3B, 3C, and 3D illustrate exemplary scenarios of the interactive session between a host user and a plurality of users to control at least one stimulation device of the host user and associated set of operative components of the at least one stimulation device, in accordance with an embodiment of the present disclosure;

FIG. 4A illustrates an exemplary representation of a user interface (UI) rendered on an interactive platform equipped in a user device associated with the host user, in accordance with an embodiment of the present disclosure;

FIG. 4B illustrates an exemplary representation of a user interface (UI) rendered to a user of the interactive platform, in accordance with an embodiment of the present disclosure;

FIG. 4C illustrates an exemplary representation of a user interface (UI) depicting a control interface of a current controller to interact with the host user, in accordance with an embodiment of the present disclosure;

FIG. 4D illustrates an exemplary representation of a user interface (UI) depicting a control interface of a waiting controller to interact with the host user, in accordance with an embodiment of the present disclosure;

FIG. 4E illustrates an exemplary representation of a user interface (UI) depicting transmission of a request to reassign operational roles in the interactive session, in accordance with an embodiment of the present disclosure;

FIG. 5 illustrates an exemplary representation of an overall interactive session, in accordance with an embodiment of the present disclosure;

FIG. 6 illustrates a flow diagram of a computer-implemented method for providing the interactive platform to manage the interactive session between the host user and the plurality of users, in accordance with an embodiment of the present disclosure; and

FIG. 7 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features.

### Overview

The present disclosure relates to methods and systems for providing an interactive platform to facilitate an interactive session between a host user and a plurality of users. The interactive session is associated with at least one stimulation device of the host user and a set of operative components corresponding to the at least one stimulation device. In various embodiments, a system establishes the interactive session between the plurality of users in an interactive platform. Further, a role pool is created in the interactive session. The role pool includes at least one controlling role and one or more controlled roles. The role pool is created in the interactive session by assigning the at least one controlling role and the one or more controlled roles to a corresponding user of the plurality of users. The interactive session is divided into one or more sub interactive sessions based at least on a set of predetermined rules. The one or more sub interactive sessions enable the one or more controlling roles to operate one of at least one stimulation device and a set of operative components associated with each of the at least one stimulation device of the one or more controlled roles. The system is configured to receive at least one control instruction from the plurality of users in the interactive session and to operate the corresponding stimulation device or operative component according to the associated sub interactive session.

In some embodiments, identifiers, such as a first identifier and a second identifier, are assigned to the at least one stimulation device and the set of operative components of the at least one stimulation device, respectively, for generating the one or more control links. The interactive platform further supports reassignment of an operational role (such as the controlled role and the controlling role) of the host user to a user of the plurality of users based on acceptance of a request and validation of connectivity conditions.

In some embodiments, an overall interactive session is supported, wherein a plurality of host users associated with respective interactive sessions join the overall interactive session. Each interactive session corresponds to a sub interactive session within the overall interactive session, and control commands enable the plurality of users to interact with the at least one stimulation device and the set of operative components associated with each host user according to predefined participation conditions.

The present disclosure provides several technical advantages that support remote operation of network-connected stimulation devices. It is to be noted that, by dividing an interactive session into one or more sub interactive sessions associated with the at least one stimulation device and the set of operative components, the disclosed system enables structured allocation of control authority. The segmentation of the interactive session reduces simultaneous conflicting control instructions directed to same stimulation device or operative component. This results in improving the operational stability of the device and reducing unintended device behavior. The association of the control links with identifiers corresponding to the stimulation device and the set of operative components enables precise mapping between user-issued control instructions and target device endpoints. This improves signal routing accuracy and reduces erroneous command execution.

Further, the disclosed system enables concurrent participation of the plurality of users within a single interactive session while maintaining defined participation states and operational roles. By dividing the interactive session based on the set of predetermined rules, the system provides controlled allocation of device access without requiring static device pairing or unrestricted broadcast control. This architecture improves multi-user coordination and reduces computational overhead associated with resolving conflicting control inputs in real time. As a result, the system improves efficiency of server-side session management and device command processing.

Furthermore, the disclosed system supports reassignment of an operational role of the host user to a user of the plurality of users, subject to a set of predefined conditions and connectivity validation. By determining connectivity status between the stimulation device and a user terminal prior to reassignment, the system ensures that role transitions occur only when an operable hardware connection exists. This validation mechanism improves system reliability by preventing invalid role transitions and avoiding transmission of control instructions to disconnected or unavailable devices. The connectivity verification process reduces failed command execution and enhances synchronization between user devices and stimulation devices. Additionally, through the use of predefined durations and participation conditions, the disclosed system enables controlled limitation of control authority within an interactive session. The termination or expiration of control links after a predefined time reduces persistent or unintended control states and improves predictable management of device operation. This approach enhances system-level control over device access, reduces prolonged exposure to stale authorization states, and improves operational determinism within the interactive platform.

Moreover, the disclosed system supports an overall interactive session that associates multiple interactive sessions hosted on at least one interactive platform and one or more third-party interactive platforms. By generating control commands corresponding to the sub interactive sessions within the overall interactive session, the system provides coordinated interaction across multiple platforms. This architecture improves interoperability between heterogeneous interactive platforms and enables unified session management without requiring modification of underlying device hardware. The centralized coordination reduces fragmentation of control states and improves scalability of multi-platform interactive environments.

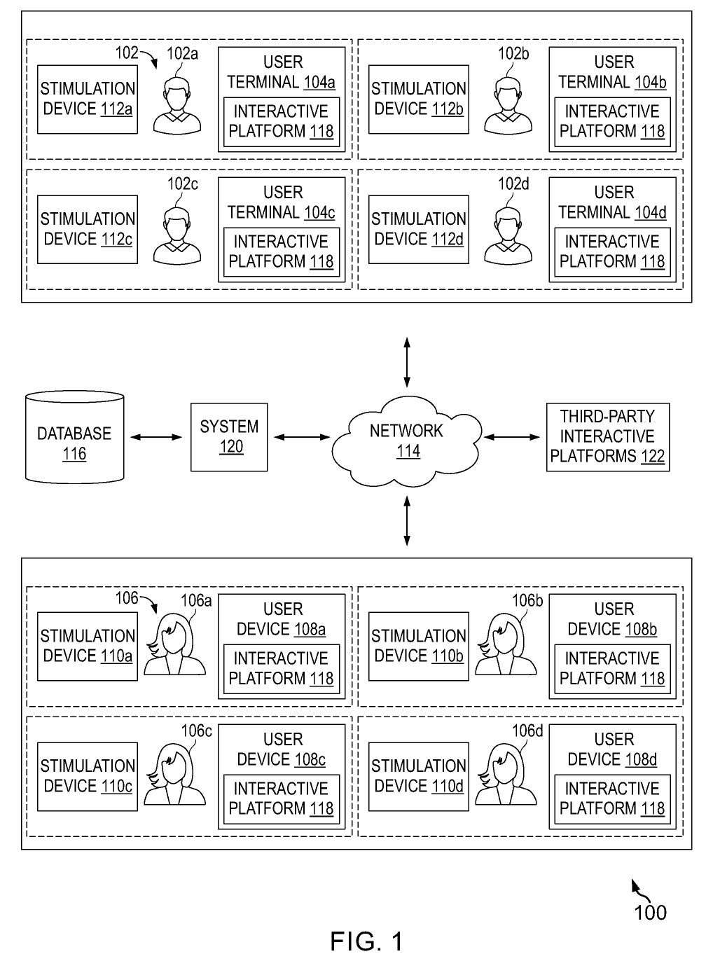

Various embodiments of the present disclosure are described hereinafter with reference to FIGS. 1-7.

FIG. 1 illustrates an example representation of an environment 100 related to at least some example embodiments of the present disclosure. Although the environment 100 is presented in one arrangement, other arrangements are also possible where the parts of the environment 100 (or other parts) are arranged or interconnected differently. The environment 100 generally includes a plurality of users, such as a user 102a, a user 102b, a user 102c, and a user 102d. For description purposes, only four users are shown, however, there can be any number of users. The users 102a-102d are collectively referred to as the plurality of users 102 or the users 102. Additionally, the users 102a-102d are referred to as a plurality of participating users. Each of the users 102a, 102b, 102c, and 102d is associated with a user terminal 104a, a user terminal 104b, a user terminal 104c, and a user terminal 104d respectively. The user terminals 104a-104d may include at least a laptop computer, a phablet computer, a handheld personal computer, a virtual reality (VR) device, a netbook, a Web book, a tablet computing device, a smartphone, or other mobile computing devices.

Further, the environment 100 includes a plurality of host users, such as a host user 106a, a host user 106b, a host user 106c, and a host user 106d. For description purposes, only four host users are shown, however, there can be any number of host users. The host users 106a-106dare collectively referred to as the plurality of host users 106 or the host users 106.Each of the host users 106a, 106b, 106c, and 106dis associated with a user device 108a, a user device 108b, a user device 108c, and a user device 108d, respectively. The user devices 108a-108d may include at least a laptop computer, a phablet computer, a handheld personal computer, a virtual reality (VR) device, a netbook, a Web book, a tablet computing device, a smartphone, or other mobile computing devices. The host users 106 may be users who perform content (e.g., sexual entertainment content or sexual entertainment content broadcasting) on an interactive platform 118.

Furthermore, each of the host users 106a, 106b, 106c, and 106d are associated with at least one stimulation device 110a, at least one stimulation device 110b, at least one stimulation device 110c, and at least one stimulation device 110d, respectively. Additionally, the users 102a-102d are associated with at least one stimulation device 112a, at least one stimulation device 112b, at least one stimulation device 112c, and at least one stimulation device 112d, respectively. The stimulation devices 110a-110d and 112a-112d may include, but are not limited to, adult toys, sensory stimulation devices, interactive feedback devices, remote-controlled or network-connected devices, control terminals, peripheral devices, and the like. The stimulation devices 110a-110d and 112a-112d may be connected wirelessly with the respective user devices 108a-108d and the user terminals 104a-104d. Some examples of the wireless connectivity for enabling connection between the stimulation devices 110a-110d and 112a-112d and the user devices 108a-108d and the user terminals 104a-104d may include, but are not limited to, near field communication (NFC), wireless fidelity (Wi-Fi), Bluetooth, and the like.

Further, each of the at least one stimulation device 112a-112d and the at least one stimulation device 110a-110d associated with the respective users 102 and host users 106 includes a set of operative components. The set of operative components may include at least one of actuators, temperature regulators, liquid dispensing components, fragrance emitting components, audio devices, and the like. The set of operative components may be dedicated to operate the corresponding stimulations and/or operations associated with the at least one stimulation device 112a-112d and the at least one stimulation device 110a-110d.

Various entities in the environment 100 may connect to a network 114 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. In some instances, the network 114 may include a secure protocol (e.g., Hypertext Transfer Protocol (HTTP)), and/or any other protocol, or set of protocols. In an example embodiment, the network 114 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof.

The environment 100 further includes a system 120. The system 120 may be embodied in at least one computing device in communication with the network 114. The system 120 is configured to host and manage the interactive platform 118. The interactive platform 118 may be equipped in the user device 108a-108d and the user terminals 104a-104d. The interactive platform 118 may be a cloud hosting platform, a cloud streaming platform, or a software as a service (SaaS) based hosting platform, or any other hosting platform. The system 120 may be specifically configured, via executable instructions, to perform one or more of the operations described herein. In general, the system 120 is configured to manage an interactive session related to adult entertainment activities, which will be explained further in detail.

Further, one or more components of the interactive platform 118 may be stored in a database 116 associated with the system 120. The interactive platform 118 is a set of computer-executable codes configured to manage the adult entertainment activities (e.g., operating stimulation devices related to sexual activities). In one embodiment, the interactive platform 118 may be accessed as a web-based application on the user devices 108a-108d and the user terminals 104a-104d. In another embodiment, the user devices 108a-108d and the user terminals 104a-104d may access an instance of the interactive platform 118 from the system 120 for installing on the user devices 108a-108d and the user terminals 104a-104d using application stores associated with operating systems such as Apple iOS®, Android™ OS, Google Chrome OS, Symbian OS®, Windows Mobile® OS, and the like.

Additionally, the environment 100 includes one or more third-party interactive platforms 122 communicably coupled to the network 114. The one or more third-party interactive platforms 122 are communicably coupled to the system 120. The one or more third-party interactive platforms 122 may include similar instructions of the interactive platform 118 to manage the interactive session related to adult entertainment activities.

In an embodiment, the host user 106a of the plurality of host users 106 may create the interactive session through the interactive platform 118 equipped in the user device 108a. For description purposes, the host user 106a is referred to for describing the present disclosure. It should be understood that one or more operations performed by the host user 106a may be performed by other host users, such as the host users 106b-106d, without limiting the scope of the present disclosure. The interactive platform 118 may be a logical interactive environment configured to manage the adult interactive activities between the plurality of host users 106 and the plurality of users 102. In general, the interactive session refers to a user-perceivable interactive session, such as a chat room, a session page, a control room, or any other similar interactive session.

Further, the host user 106a may generate one or more control links corresponding to the interactive session. The one or more control links may include, but are not limited to, a uniform resource locator (URL), a quick response (QR) code, an Identification (ID) code, an invitation code, and the like. The system 120 transmits the one or more control links to the plurality of users 102 through the interactive platform 118 to join the interactive session. Each control link of the one or more control links is configured to operate one of a corresponding stimulation device of the at least one stimulation device 110a-110d and a corresponding operative component of the set of operative components associated with the at least one stimulation device 110a-110d. Additionally, the system 120 may assign a set of identifiers to the at least one stimulation device 110a and the set of operative components of the at least one stimulation device 110a for creating the one or more control links corresponding to the interactive session. The set of identifiers may include, but are not limited to, session identifier (SID), operation code (OPCODE), access token, authorization code, and the like. The set of identifiers includes a first identifier and a second identifier. In particular, the system 120 assigns the first identifier to the at least one stimulation device 110a, and the second identifier to the set of operative components of the at least one stimulation device 110a. For example, the first identifier assigned to the at least one stimulation device 110a may be configured to trigger a stimulation, such as an electric stimulus. The second identifier assigned to the set of operative components of the at least one stimulation device 110a may be configured to perform corresponding actions, such as dispensing of liquid or emitting fragrances. Further, the first identifier and the second identifier represent the corresponding stimulation device and the set of operative components are appended in each control link and transmitted to each of the plurality of users 102. In other words, each of the first identifier and the second identifier represents an individual controlled object.

In one embodiment, the plurality of users 102 may not accept the one or more control links being transmitted by the system 120. In this scenario, the one or more control links may be terminated after the lapse of a predetermined time (e.g., 2 minutes), or the host user 106a may disable the one or more control links after the predetermined time. In another embodiment, the plurality of users 102 may accept the one or more control links transmitted by the system 120. In this scenario, the system 120 receives a confirmation message corresponding to the acceptance of the at least one control link by the respective user of the plurality of users 102.

Furthermore, the system 120 establishes the interactive session between the host user 106a and the plurality of users 102 based on the receipt of the confirmation message. In response, the system 120 renders a user interface (not shown in FIG.) on the interactive platform 118 equipped in each of the user terminals 104a-104d associated with the plurality of users 102 joined using the one or more control links. The user interface renders the data related to participants (i.e., the plurality of host users 106 and the plurality of users 102), roles corresponding to the participants, state of the at least one stimulation device, such as the at least one stimulation device 110a, connectivity status, signal strength, and the like. In some embodiments, the interactive session may be implemented as a one-to-one session between the host user 106a and the user 102a of the plurality of the users 102.

In some embodiments, the plurality of users 102 may initiate a request (e.g., a non-unilateral invitation) to the system 120 to access an interactive session hosted in the interactive platform 118. In this scenario, the system 120 may implement a randomized selection mode to establish the interactive session between the host user 106a and the plurality of users 102. Specifically, the system 120 may select a random user (e.g., the user 102a) from the plurality of users 102 upon receipt of the request from the users 102. Thereafter, the system 120 establishes the interactive session between the host user 106a and the random user (i.e., the user 102a).

In some embdiments, the system 120 may enable a profile matching mode to establish the interactive session between the host user 106a and the plurality of users 102 upon receipt of the request (e.g., a non-unilateral invitation) to access an interactive session hosted in the interactive platform 118. The profile matching mode corresponds to analyzing profile data of the host user 106a and each of the plurality of users 102. The profile data may include one or more attributes, such as hobbies, historical behaviours, historical session information, and the like. The system 120 identifies the one or more attributes of the profile data matching between the host user 106a and the plurality of users 102. Upon the successful matching of the profile data, the system 120 establishes the interactive session between the host user 106a and the plurality of users 102. For example, the host profile data may include a teledidonic device (i.e., the at least one stimulation device 110a). The system 120 identifies the user 102a associated with the profile data, including the teledildonic device. The system 120 establishes the interactive session between the host user 106a and the user 102a based on the matching profile data.

In some embodiments, the host user 106a may initiate the interactive session in the interactive platform 118. In particular, the host user 106a may transmit the one or more control links to the users 102. Upon acceptance of the control links, the system 120 establishes the interactive session between the host user 106a and the plurality of users 102 (such as the user 102a, the user 102b, the user 102c, and the user 102d). The plurality of users 102 may operate the at least one stimulation device 106a associated with the host user 106a in the interactive session. The system 120 may render the graphical user interface in the user terminals 104a-104d associated with the plurality of users 102. Herien, the users 102 may be associated with at least one controlling role in the interactive session. The controlling role enables the users 102 to control the at least one stimulation device 106a associated with the host user 106a in the interactive session. It should be understood that, in this scenario, the host user 106a is associated with a controlled role among one or more controlled roles in the interactive session, which will be described further in detail.

In particular, the system 120 is configured to create a role pool associated with the interactive session. The role pool includes the at least one controlling role and the one or more controlled roles. The at least one controlling role corresponds to at least one user (i.e., the user 102a) authorized to provide the at least one control instruction to operate at least one of the at least one stimulation device 110a and the set of operative components of the at least one stimulation device 110a. The one or more controlled roles correspond to at least one user (e.g., the host user 106a) associated with a stimulation device (i.e., the at least one stimulation device 110a) receiving the at least one control instruction from the controlling role in the interactive session. The system 120 creates the role pool by assigning the at least one controlling role and the one more controller roles to a corresponding user of the plurality of users 102.

Upon the establishment of the interactive session and the assigning of an operational role (such as the controlling role and/or the controlled role) between the host user 106a and the plurality of users 102, the system 120 divides the interactive session into one or more sub interactive sessions based at least one stimulation device, the set of operative components associated with the one or more controlled roles, or a combination thereof. The one or more sub interactive sessions enable the plurality of users 102 (i.e., the at least one controlling role) to operate at least one of the at least one stimulation device 110a and the set of operative components associated with each of the at least one stimulation device 110a of the host user 106a (i.e., the one or more controlled roles).

In some embodiments, each sub-interactive session corresponds an internal control mode, wherein the control mode of each sub-interactive session is generated according to a set of predetermined rules. The set of predetermined rules may include at least one of a amount of tokens provided by the controlling role to the controlled role, a configuration setting defined by a host user 106a, predefined sequential order and a user-account level of a controlling role. The one or more sub interactive sessions may correspond to an internal control mode within the interactive session. For example, the at least one controlling role(i.e., the user 102a) may provide at least one control instruction based on the set of predetermined rules, such as the predefined sequential order, the configuration setting, or a predefined time (e.g., 5 minutes). For example, a host user (i.e., the host user 106a) may set the control duration of 5 minutes (i.e., the predefined time) within the interactive session. The at least one controlling role(i.e., the plurality of users 102) of the interactive session have 5 minutes to control the at least one stimulation device 110a in a simultaneous or turn-based manner, that is determined based on the set of predetermined rules. In this example scenario, the set of predetermined rules may include a control duration for each user of the plurality of users 102. The system 120 allows each of the plurality of users 102 to control the at least one stimulation device 110a until the lapse of the control duration in the turn based manner or simultaneously based on the set of predetermined rules. The predetermined time determined by the host user 106a may be uniform or non-uniform based on the number of tokens or subscription level of the plurality of users 102. In another example, a host user may assign operative component 302a to a user 102a and assign operative component 302b to user 102b, such that different controlling roles are granted control authority over different operative components. In some embodiments, the viewer (i.e., the user 102a) providing the number of tokens higher than the other users (e.g., the users 102b-102d) is authorized to provide the at least one control instruction to operate at least one of the at least one stimulation device 110a and the set of operative components of the at least one stimulation device 110a.

The set of predetermined rules further includes a quantity of tokens provided by the viewer, a configuration setting defined by the host user, an order of the viewers access the interactive session and a user-account level of a viewer. In some embodiments, the amount of tokens provided by the viewer to the host user may determine an allocation of the plurality of sub-interactive sessions. For example, a viewer providing a greater amount of tokens to host user may be granted access to a sub-interactive session associated with a greater control authority, may be allocated a greater number of sub-interactive sessions, and/or may be given priority in selecting one or more sub-interactive sessions. In one example, a viewer providing the highest amount of tokens may be granted priority to select a desired sub-interactive session. In some embodiments, the host user may define one or more allocation criteria for assigning the plurality of sub-interactive sessions. For example, the plurality of sub-interactive sessions may be allocated according to an order in which viewers access one or more control links. In one example, the user 102a accessing a control link may be assigned a sub-interactive session associated with operative component 302a. In some embodiments, the plurality of sub-interactive sessions may be allocated according to one or more attributes associated with an account of a viewer. For example, a viewer having a highest account level, contribution level, tipping level, membership level, reputation level, or other user-ranking metric may be granted control authority over a designated operative component.

In some embodiments, each sub interactive session is scoped to the corresponding controlling role, such that a controlling role scoped to one sub interactive session is precluded from operating an operative component scoped to another controlling role, whereby a plurality of controlling roles are enabled to operate respective operative components of the host user 106a concurrently and in mutual isolation.

In some embodiments, the one or more control links may enable multiple users (i.e., the plurality of users 102) to access the interactive session. The system 120 establishes the interactive session between the host user 106a and the plurality of users 102 (such as the user 102a, the user 102b, the user 102c, and the user 102d). In particular, the system 120 may assign the controlled role to the host user 102a and the controlling role to the plurality of users 102. The system 120 may enable multiple controlling users (i.e., the plurality of users 102) to operate one of the at least stimulation device 110a and the set of operative components associated with each of the at least one stimulation device 110a of the host user 106a (i.e., the controlled role) in the interactive session. For example, the system 120 may enable the interactive session between a submissive (i.e., the host user 106a) and a multiple dominants (i.e., the plurality of users 102) to operate the teledildonic device (i.e., the at least one stimulation device 110a) of the submissive in the interactive session.

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices.

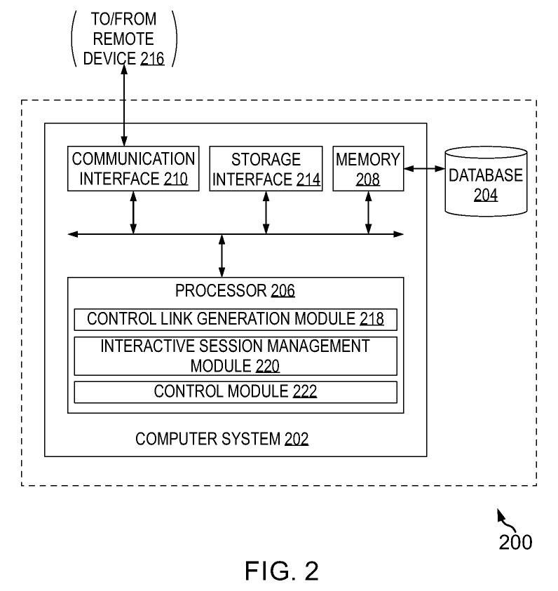

FIG. 2 illustrates a simplified block diagram of a system 200 for managing the interactive session related to the adult entertainment activity, in accordance with an embodiment of the present disclosure. Examples of the system 200 may include, but are not limited to, the system 120 as shown in FIG. 1. The system 200 includes a computer system 202 and a database 204. The computer system 202 includes at least one processor 206 for executing instructions, a memory 208, a communication interface 210, and a storage interface 214. The one or more components of the computer system 202 communicate with each other via a bus 212.

In one embodiment, the database 204 is integrated within the computer system 202 and configured to store an instance of the interactive platform 118 and one or more components of the interactive platform 118. In addition, the database 204 is configured to store media content, control parameters for operating sexual stimulation devices, interaction elements, and the like. The computer system 202 may include one or more hard disk drives as the database 204. The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute computer-readable instructions. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the system 200, as described herein. In some embodiments, the memory 208 may be realized in the form of a database or cloud storage working in conjunction with the system 200, without deviating from the scope of the present disclosure.

The processor 206 is operatively coupled to the communication interface 210 such that the processor 206 is capable of communicating with a remote device 216 such as the user devices 108a-108d, the user terminals 104a-104d, the sexual stimulation devices 110a-110d, the sexual stimulation device 112a-112d, or with any entity connected to the network 114 as shown in FIG. 1.

It is noted that the system 200 as illustrated and hereinafter described is merely illustrative of an apparatus that could benefit from embodiments of the present disclosure and, therefore, should not be taken to limit the scope of the present disclosure. It is noted that the system 200 may include fewer or more components than those depicted in FIG. 2.

In one embodiment, the processor 206 includes a control link generation module 218, an interactive session management module 220, and a control module 222. The processor 206 may include other engines apart from those depicted in FIG. 2, therefore, it should not be taken to limit the scope of the present disclosure.

The control link generation module 218 includes suitable logic and/or interfaces to generate the one or more control links. Each control link of the one or more control links is generated based on a corresponding stimulation device of the at least one stimulation device 110a, the corresponding operative component of the set of operative components associated with the at least one stimulation device 110a, or a combination thereof. For example, the host user 106a may be associated with a teledildonic device (i.e., the at least one stimulation device 110a). The control link generation module 218 generates a control link corresponding to operating the teledildonic device of the host user 106a. The one or more control links may be generated to allow the plurality of users 102 to access the interactive session. The one or more control links may be transmitted to the plurality of users 102 through the interactive platform 118. The one or more control links received by the plurality of users 102 may be active for the predefined time. The system 200 permits the plurality of users 102 to join the interactive session prior to the lapse of the predefined time. In one embodiment, the one or more control links may be a single-use access link configured to permit the one-time joining of the plurality of users 102. In some embodiments, the one or more control links may be a multi-use access link configured to permit the repeated joining of the plurality of users 102. The system 200 receives the confirmation message from the plurality of users 102 based on the acceptance of the one or more control links. Further, the system 200 establishes the interactive session to enable a secure interaction between the host user 106a and the plurality of users 102. For example, the submissive (i.e., the host user 106a) may generate the one or more control links related to the adult entertainment activity (i.e., the interactive session). The one or more control links are transmitted to the dominants (i.e., the plurality of users 102) through the interactive platform 118. The dominants may accept the one or more control links, and transmit the confirmation message indicative of their acceptance, to the system 200 through the interactive platform 118.

The interactive session management module 220 may include suitable logic and/or interfaces to manage operations related to the interactive session. Further, the system 200 establishes the interaction between the host user 106a and the plurality of users 102 to perform the adult entertainment activity based on the receipt of the confirmation message. The system 200 assigns the controlled role among the one or more controlled roles to the host user 106a performing sexual activities in the interactive session. The system 200 assigns the controlling role among the at least one controlling role to the the plurality of users 102 in the interactive session. Upon the establishment of the interactive session, the system 200 divides the interactive session to the one or more sub interactive sessions based on the set of predetermined rules. Each sub interactive session of the interactove session is generated based on a corresponding control link of the one or more control links. Further, each sub interactive session enables the at least one controlling role (e.g., the user 102a) to operate one of a corresponding stimulation device of the at least one stimulation device 110a and a corresponding operating component of the set of operative components associated with the at least one stimulation device 110a. The one or more control links may be appended with the first identifier and the second identifier as described above. The first identifier and the second identifier indicate the at least one stimulation device 110a and the set of operative components of each of the at least one stimulation device 110a, respectively.

The control signal generation module 222 may include suitable logic and/or interfaces to receive the at least one control instruction from the plurality of users 102 of the interactive session. The system 200 may store the at least one control instruction received from the plurality of users 102 in the database 204. The at least one control instruction may trigger an action in at least one of the at least one stimulation device 110a and the set of operative components associated with the at least one stimulation device 110a. Each user of the plurality of users 102 may provide the at least one control instruction simultaneously or in a turn-based manner to operate at least one of the at least one stimulation device 110a and the set of operative components associated with the stimulation device 110a. Additionally, the one or more control links received by the plurality of users 102 may be associated with the predefined time for operating the at least one stimulation device 110a and the set of operative components of the at least one stimulation device 110a, or a combination thereof, within the interactive session. The predefined time associated with the one or more links corresponds to an operation time allocated to each of the plurality of users 102 in the interactive session. Upon the lapse of the predefined time, the one or more control links associated with the corresponding user of the plurality of users 102 is terminated (or deactivated), hence the corresponding user is unable to provide the at least one control instruction to the host user 106a within the interactive session. For example, the system 200 may assign 5 minutes as the predefined time period for each user of the plurality of users 102 (i.e., the controlling role) to provide the at least one control instruction for operating the at least one stimulation device 110a and the set of operative components of the at least one stimulation device 110a, or a combination thereof, within the interactive session. Hence, each of the users 102a-102d have 5 minutes to provide inputs (i.e., the at least one control instruction) to operate the adult toy (i.e., the at least one stimulation device 110a) associated with the host user 106a (i.e., the controlled role). Upon the lapse of 5 minutes, the system 200 terminates the one or more control links for the corresponding user. It should be noted that, one or more operations of the system 200 for managing the interactive session between the users 102 and the host users 106 are further described in detail.

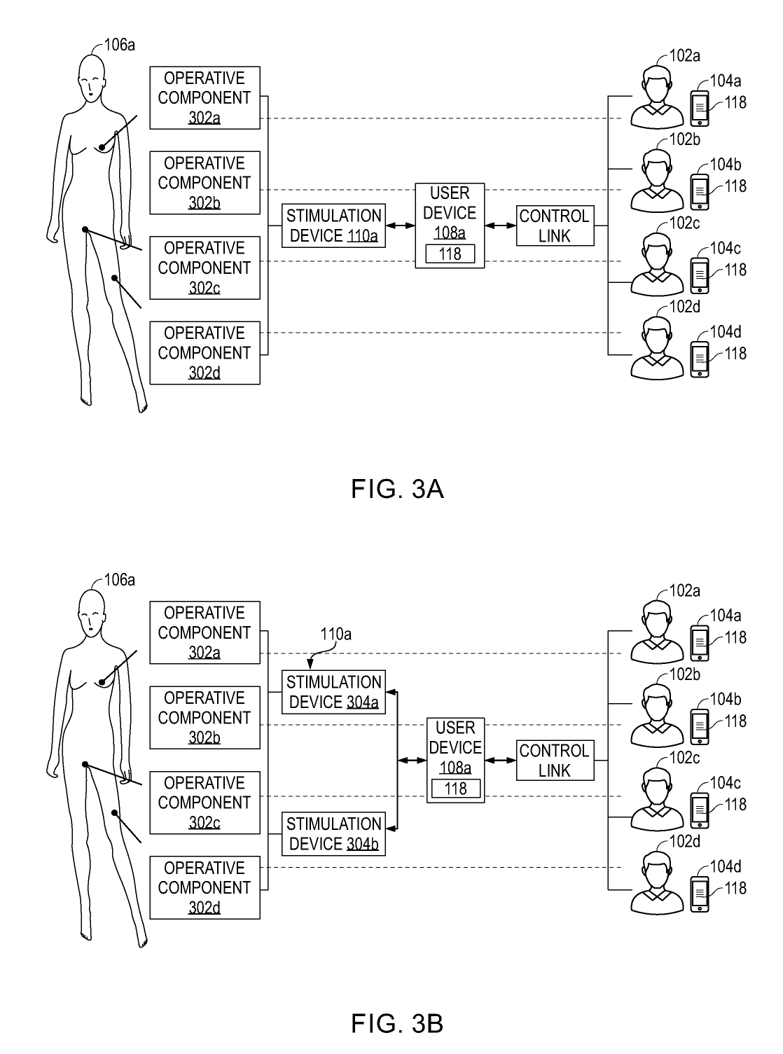

Referring to FIG. 3A in conjunction with FIG. 2, a host user (e.g., the host user 106a) is associated with the at least one stimulation device 110a. The at least one stimulation device 110a may include the set of operative components, including an operative component 302a, an operative component 302b, an operative component 302c, and an operative component 302d. For illustration purposes, only four operative components (such as the operative components 302a-302d) associated with the at least one stimulation device 110a are illustrated, however, the at least one stimulation device 110a may include any number of operative components as per the requirements. In this example scenario, the system 200 is configured to generate a control link among the one or more control links. It is to be noted that, the example scenario described with reference to FIG. 3A requires one control link that will be transmitted to multiple viewers (such as the users 102) to control the at least one stimulation device 110a, the set of operative components 302a-302d of the at least one stimulation device 110a, or a combination thereof. For example, the operative components 302a-302d may include at least one of actuators, electro-stimulation components, liquid dispensing components, fragrance emitting components, audio devices, and the like. The operative component 302a and the operative component 302b may be a vibrator to provide stimulation (such as vibration stimulations) at a breast of the host user 106a (also referred to as a target region A) and a genital region of the host user 106a (also referred to as a target region B). The operative component 302c and the operative component 302d may be an electrostimulation component configured to provide stimulation (e.g., electric stimulus/shocks) at neck of the host user 106a (also referred to as a target region C) and thigh of the host user 106a (also referred to as a target region D).

As described above, the host user 106a creates the interactive session in the interactive platform 118, and allows the users 102a-102d to access the interactive session on their respective user terminals 104a-104d through the interactive platform 118. Accessing the interactive session of the host user 106a by the users 102 is further described in detail.

As shown, the host user 106a is associated with one stimulation device (such as the at least one stimulation device 110a) and four operative components (such as the set of operative components 302a-302d). Accordingly, the system 200 appends the first identifier to the at least one stimulation device 110a, and the second identifier to each operative component of the set of operative components 302a-302d. The control link generation module 218 creates the control link by appending the first identifier of the at least one stimulation device 110a, and the second identifier of each operative component of the set of operative components 302a-302d. Herein, the control link is transmitted to each of the users 102a-102d for establishing the interactive session between the host user 106a and the users 102a-102d. The transmission of the control link with the first and second identifiers may be predefined for each user by the system 200 or by the host user 106a.

The interactive session management module 220 establishes the interactive session between the host user 106a and the users 102 on the interactive platform 118 based on the receipt of the confirmation message related to the acceptance of the control link by the users 102. Further, the system 200 divides the interactive session into the one or more sub interactive sessions based on the set of predetermined rules as explained with reference to FIG. 1. The one or more sub interactive sessions enable the users 102 to operate the stimulation device 110a and/or the operative components 302a-302dof the stimulation device 110a using the control link appended with the corresponding first identifier and second identifier. For example, a control link appended with the first identifier to the at least one stimulation device 110a, and the second identifier of the operative component 302a may be transmitted to the user 102a. Herein, the control link appended with the first identifier to the at least one stimulation device 110a, and the second identifier of the operative component 302a being transmitted to the user 102a corresponds to a sub interactive session within the interactive session. Similarly, the control link appended with the first identifier to the at least one stimulation device 110a, and the second identifier of the operative component 302b may be transmitted to the user 102b, and so on. Accordingly, the user 102b with the control link for operating the operative component 302b may form a sub interactive session within the interactive session. The transmission of the control link with first and second identifiers allows the users 102a-102c to access the control functionalities of the corresponding operative component of the stimulation device 110a.

Further, the control signal generation module 222 receives the at least one control instruction from the users 102 to operate the stimulation device 110a. For example, the control link associated with the user 102a, allows the user 102a to control the operative component 302a of the stimulation device 110a. In particular, the user 102aprovides the at least one control instruction to operate the operative component 302a of the stimulation device 110a of the host user 106a. The at least one control instruction may include instructions to operate the operative component 302a at the target region A (such as the breast). The at least one control instruction may be related to triggering the stimulation (such as vibration) using the stimulation device 110a at the target region A. Similarly, the users 102b-102d may provide the at least one control instruction to operate the corresponding operative components 302b-302d of the stimulation device 110a. The operative components 302b-302d, when operated, may provide stimulation to the target regions B, C, and D, respectively. In one embodiment, the target regions A, B, C, and D may be predefined by the host user 106a. In another embodiment, the target regions A, B, C, and D may be defined based on the set of predetermined rules, or selected by the users 102.

Referring to FIG. 3B in conjunction with FIG. 2, a host user (e.g., the host user 106a) is associated with the at least one stimulation device 110a. As shown, the at least one stimulation device 110a includes a stimulation device 304a and a stimulation device 304b. In this example scenario, the stimulation device 110a includes two stimulation devices associated with the host user 106a. However, the host user 106a may have any number of stimulation devices, hence it should not be considered to limit the scope of the present disclosure. Further, in this example scenario, the operative component 302a and the operative component 302b may be associated with the stimulation device 304a of the at least one stimulation device 110a, and the operative component 302c and the operative component 302d may be associated with the stimulation device 304b of the at least one stimulation device 110a. For example, the operative component 302a and the operative component 302b may be the vibrator to provide stimulation (such as vibration stimulations) at the target region A and the target region B, respectively. The operative component 302c and the operative component 302d may be an electro-stimulation component configured to provide stimulation (e.g., electric stimulus/shocks) at the target region C and the target region D, respectively.

In this scenario, the system 200 assigns the first identifier to the stimulation devices 304a-304b, and the second identifier to each operative component of the set of operative components 302a-302d to generate the control link for transmitting to the users 102. Further, the generation of the control link, establishment of the interactive session, and dividing the interactive session into the one or more sub interactive sessions follows the similar method as explained above with reference to FIG. 3A, hence, they are not reiterated for the sake of brevity.

In this example scenario, the user 102a may receive the control link appended with the first identifier and the second identifier of the corresponding stimulation device 304a and operative components 302a and 302b. It should be noted that the control link received by the user 102a may be appended with the first identifier of the stimulation device 304b and the second identifier of the operative component 302b. Similarly, the control link received by the users 102b-102d may include the first identifier of the stimulation device 304a and the stimulation device 304b, and the second identifier of the operative components 302a-302d of the host user 106a.

The at least one control instruction provided by the user 102a may include instructions to operate the operative component 302a and the operative component 302b at the target region A and the target region B, respectively. The at least one control instruction may be related to triggering the stimulation (such as vibration) using the operative components 302a and 302b of the stimulation device 304a at the target region A and the target region B, respectively. Similarly, the users 102b-102d may provide the at least one control instruction to operate the corresponding operative components 302a-302d of the stimulation device 304b.

Referring to FIG. 3C in conjunction with FIG. 2, a host user (e.g., the host user 106a) is associated with the stimulation device 110a. The operations related to the stimulation device 110aand the set of operational components 302a-302d are operated using at least one control instruction follows the similar method as explained with reference to FIG. 3A, hence, they are not reiterated for the sake of brevity.

In this example scenario, the system 200 is configured to generate the one or more control links. The one or more control links include a first control link, a second control link, a third control link, and a fourth control link. For illustration purposes, only four control links (i.e., the one or more control links) are depicted, however, the system 200 may generate any number of control links to manage the interactive session. It is to be noted that the example scenario described with reference to FIG. 3A requires the one or more control links that will be transmitted to multiple viewers (such as the users 102) to control the at least one stimulation device 110a, the set of operative components 302a-302d of the at least one stimulation device 110a, or a combination thereof.

As described above, the host user 106a creates the interactive session in the interactive platform 118, and allows the users 102a-102d to access the interactive session on their respective user devices 104a-104d through the interactive platform 118. The control link generation module 218 creates the one or more control links based on appending the first identifier of the at least one stimulation device 110a, and the second identifier of each operative component of the set of operative components 302a-302d. Herein, the one or more control links are transmitted to each of the users 102a-102d for establishing the interactive session between the host user 106a and the users 102a-102d.

Further, transmission of the one or more links, establishment of the interactive session, dividing of the interactive session into the one or more sub interactive sessions follow the same method as explained in FIG. 3A. The one or more sub interactive sessions enable the users 102 to operate the stimulation device 110a and the set of operative components 302a-302d of the stimulation device 110a using the corresponding control link of the one or more control links. For example, the first control link is appended with the first identifier of the at least one stimulation device 110a and the second identifier of the operative component 302a, and is further transmitted to the user 102a. Herein, the first control link appended with the first identifier of the at least one stimulation device 110a and the second identifier of the operative component 302a being transmitted to the user 102a corresponds to a sub interactive session within the interactive session. Similarly, the second control link, the third control link, and the fourth control link are appended with the first identifier of the at least one stimulation device 110a, and the second identifier of the corresponding operative component 302b, 302c, and 302d, and may be transmitted to the respective user 102b, 102c, and 102d. Accordingly, the users 102b, 102c, and 102d with the corresponding control links for operating the operative components 302b, 302c, and 302d form a sub interactive session within the interactive session. The transmission of the one or more control links allows the users 102a-102d to access the control functionalities of the corresponding operative component of the stimulation device 110a. Further, operations related to receiving the at least one control instruction from the users 102 to control the at least one stimulation device 110a, and the corresponding operative components 302a-302d at the respective target regions A, B, C, and D follows the similar method as explained in FIG. 3A, hence, they are not reiterated for the sake of brevity.

Referring to FIG. 3D in conjunction with FIG. 2, a host user (e.g., the host user 106a) is associated with the at least one stimulation device 110a. The at least one stimulation device 110amay include a stimulation device 306a, a stimulation device 306b, a stimulation device 306c, and a stimulation device 306d. For illustrative purposes, only four stimulation devices (i.e., the stimulation devices 306a-306d) are illustrated. However, the host user 106amay be associated with any number of stimulation devices. For example, the stimulation device 306amay be the vibrator configured to provide stimulation (such as vibration stimulations) at the target region A. The stimulation devices 306b, 306c, and 306dmay be an electrostimulation component configured to provide stimulation (e.g., electric stimulus/shocks) at the target region B, the target region C, and the target region D, respectively.

In this scenario, the system 200 assigns the first identifier to each of the stimulation devices 306a-306d. Thereafter, the system 200 may generate the control link by appending the corresponding first identifier of the stimulation devices 306a-306d and transmits the control link to the users 102. The user 102a receives the control link for operating the stimulation 306a. Similarly, the users 102b-102d may receive the control link for operating the stimulation devices 306b-306d, respectively. It should be noted that the control link received by the users 102b-102d allows the users 102a-102d to provide the at least one control instruction to operate the corresponding stimulation devices 306a-306d as explained above.

Referring back to FIG. 2, the system 200 may receive a request from the host user 106a of the plurality of host users 106 to reassign the controlled role of the host user 106a in the interactive session. As described above, the controlled role assigned to the host user 106a may include the role of creator performing sexual activities using one of the at least one stimulation device 110a and the set of operative components of the at least one stimulation device 110a. Further, the request is appended with the set of predetermined rules associated with the host user 106a. The system 200 transmits the request related to reassigning the controlling role to a target user (i.e., the user 102a) of the plurality of users 102 present in the interactive session. In one example, the system 200 receives an approval message indicating the acceptance of the request by the target user (i.e., the user 102a) of the users 102. In another example, the request may be accepted by multiple target users (such as the user 102b-102d) of the plurality of users 102. The system 200 may reassign the controlled role of the host user 106a to the plurality of users 102 based on an acceptance priority of the timestamp of the receipt of the approval message. For instance, the target user (i.e., the user 102a) may accept the request to reassign the controlled role within the interactive session followed by the users 102b-102d in the interactive session.

Thereafter, the system 200 checks whether the approval message is received from the target user (i.e., the user 102a) within a preset time window defined for the request. For example, the preset time window for the request may be 30 seconds. In one embodiment, the approval message of the target user received by the system 200 exceeds the preset time window. In this scenario, the approval message from the target user is determined as invalid. The system 200 may consider the subsequent approval message indicative of the acceptance of the request based on the acceptance priority. For example, the user 102bmay accept the request subsequent to the user 102a, then, the system 200 considers the user 102b for validation process to reassign the operational role in case, the user 102a fails the validation process.

In some embodiments, the request may not be accepted by any of the users 102 of the interactive session within the preset time window. In this scenario, the non-acceptance of the request by any of the users 102 may be terminated after the lapse of the preset time window, and the host user 106a is retained as the creator of the interactive session. In another embodiment, the approval message of the user 102a being received by the system 200 is within the preset time window. The system 200 determines the approval message of the user 102a as valid. Upon the successful validation of the approval message, the system 200 determines a connectivity status, such as a connected state and a disconnected state, between a stimulation device (e.g., the at least one stimulation device 112a) and the user terminal 104a of the user 102a.

In one embodiment, the at least one stimulation device 112a and the user terminal 104a associated with the user 102a are in the disconnected state. The system 200 may terminate the operation of reassigning the operational role to the user 102a and may proceed with the validation of the approval message received by the next user (e.g., the user 102b) for reassigning the operational role. For example, a toy (i.e., the at least one stimulation device 110a) and the user device 108a are in the disconnected state. The system 200 may render a waiting status in the interactive platform 118 (e.g., a graphical user interface) equipped in the user terminal 104a associated with the user 102a. In some embodiments, the user 102a associated with the controlled role may leave the interactive session. In this scenario, the system 200 assigns the controlled role to the host user (e.g., the host user 106a) of the interactive session.

In another embodiment, the at least one stimulation device 112a and the user terminal 104a of the user 102a are in a connected state. In response to the connectivity status being the connected state, the system 200 assigns the operational role of the user 102a to the host user 106a, and the operational role associated with the host user 106a to the user 102a. The interchange of the operational roles between the user 102a and the host user 106a enables the control of the at least one stimulation device 112a of the user 102a based on the set of predetermined rules within the interactive session.

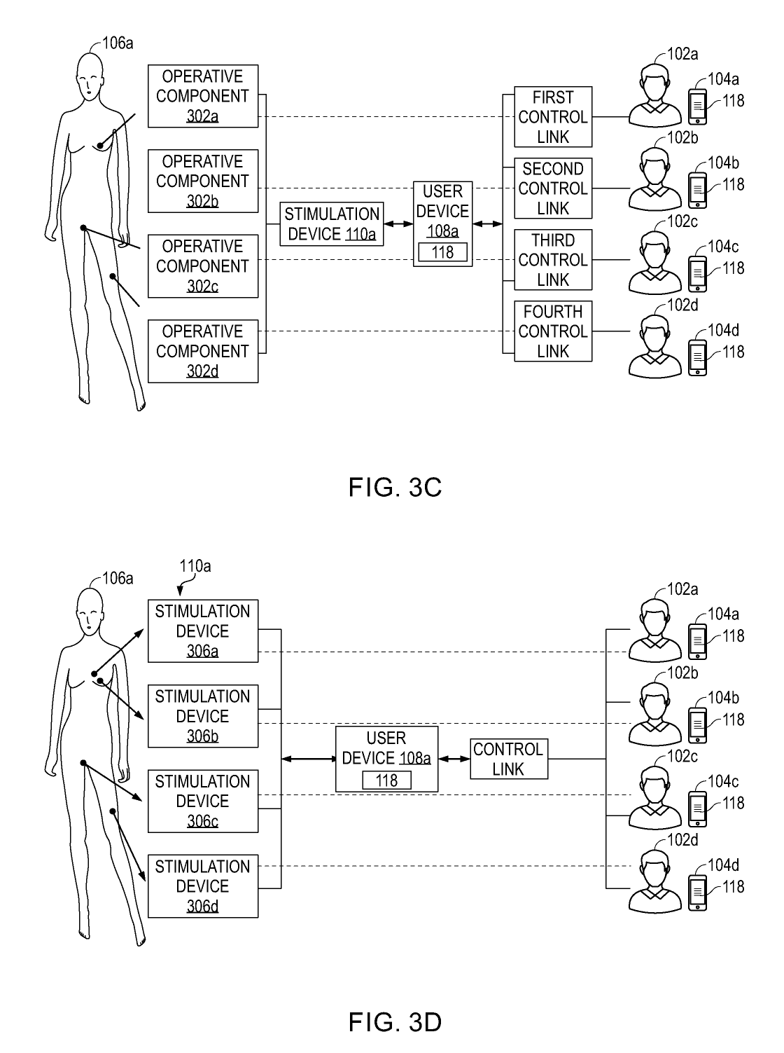

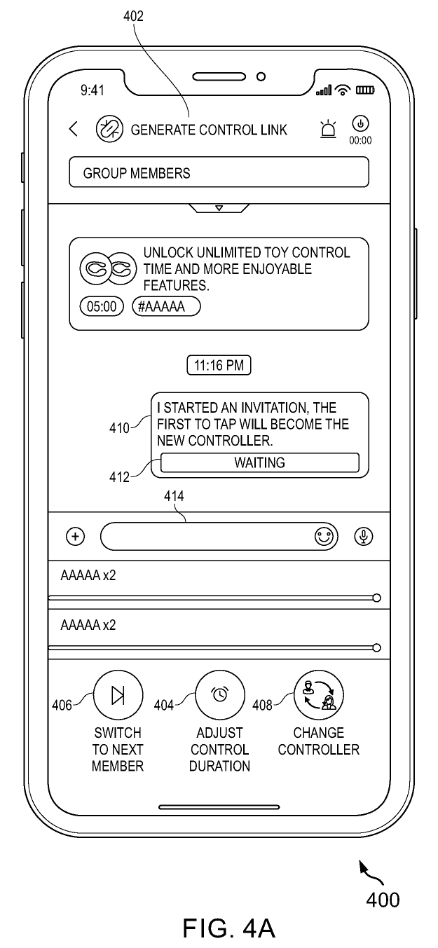

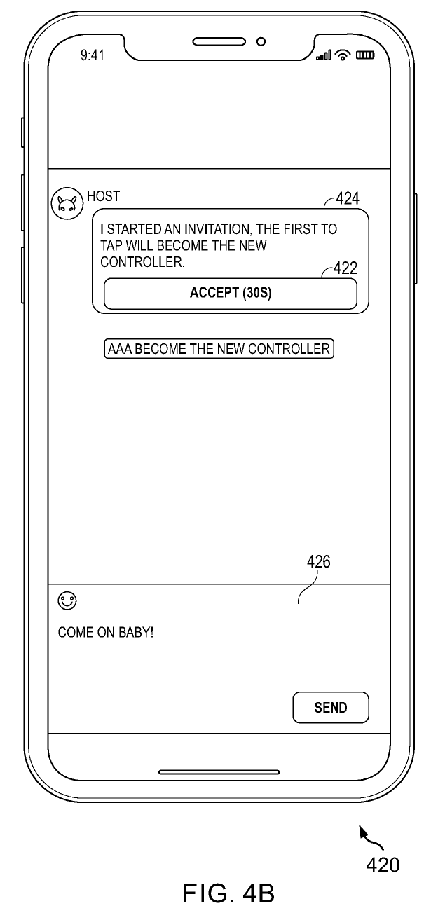

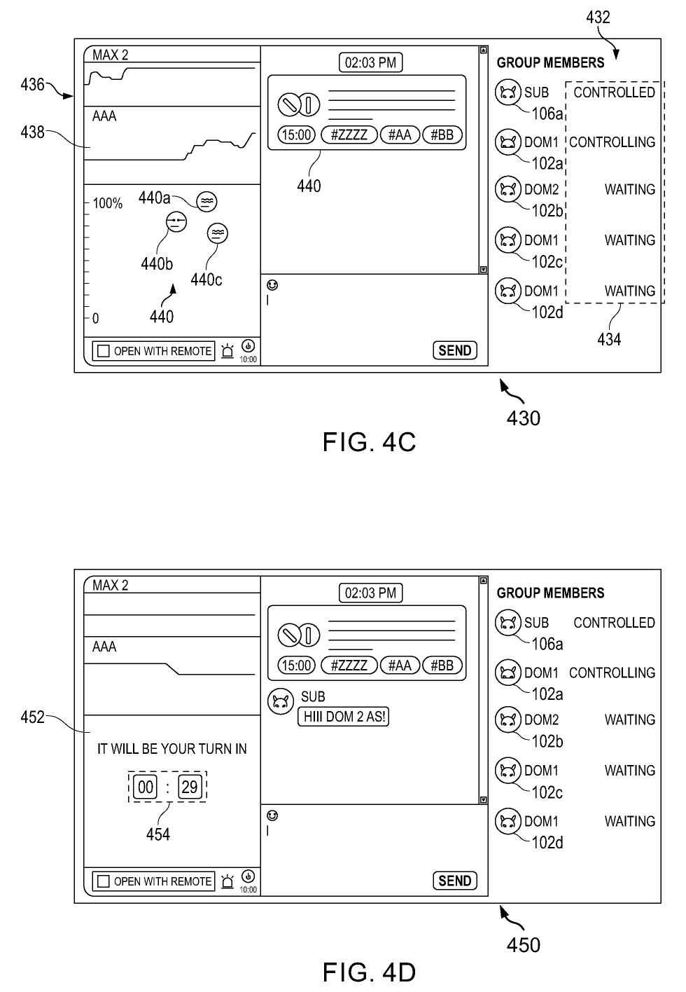

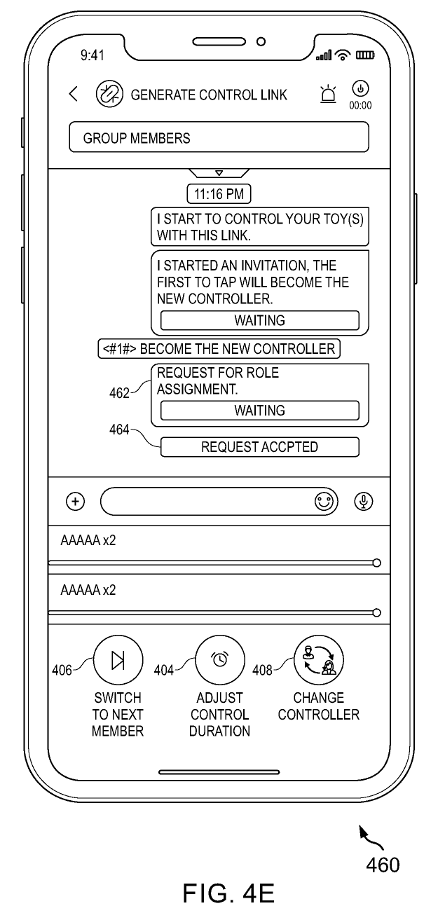

FIG. 4A illustrates an exemplary representation of a graphical user interface (GUI) 400 rendered on the interactive platform 118 equipped in the user device 108a associated with the host user 106a, in accordance with an embodiment of the present disclosure. The graphical user interface (GUI) 400 associated with the host user 106a may include one or more options such as a generate control link option 402, an adjust control duration option 404, a switch to next member option 406, and a change controller option 408.

The host user 106a may select the generate control link option 402 in the GUI 400. The selection of the generate control link option 402 may trigger the control link generation module 218 of the system 200 to generate the one or more control links. It is to be noted that, prior to the generation of the one or more control links, the system 200 checks the connectivity status between the at least one stimulation device 110a and the user device 108a. Further, the system 200 transmits the one or more control links to the users 102. The system 200 may render a message 410 (e.g., I started an invitation, tap to become a controller) associated with a real-time status 412 of the one or more control links (as shown in FIG. 4A). The message 410 including the real-time status 412 is rendered in the interactive platform 118 for the host user 106, and the users 102 who received the one or more control links of the host user 106a. The real-time status of the one or more control links may include waiting, expired, and the like.

Further, the adjust control duration option 404 allows the host user 106a to define a predefined duration for operating the at least one stimulation device 110a and/or each of the set of operative components of the stimulation device 110a. Additionally, the GUI 400 is associated with an input field 414 to enable interaction between the host user 106a and the users 102. The input field 414 may enable the interaction using a text, a graphical symbol, voice notes, and the like.

Further, the switch to next member option 406 allows the host user 106a to transfer the authority of operating at least one of the at least one stimulation device 110a and the set of operative components from the user 102a to a next user (e.g., the user 102b) in the interactive session. Furthermore, the host user 106a may provide inputs related to the selection of the change controller option 408 in the GUI 400. In response to the selection of the change controller option 408, the host user 106a is rendered with a user interface (GUI) to manage the switching of the controlled role and the controlling role between the host user 106a and the user 102a, , which will be described with reference to FIG. 4E.

FIG. 4B illustrates an exemplary representation of a graphical user interface (GUI) 420 rendered to a user of the interactive platform 118, in accordance with an embodiment of the present disclosure. The GUI 420 is rendered to the user, such as the user 102a of the interactive platform 118, to join the interactive session being hosted by the host user 106a, as described with reference to FIG. 4A. As shown, the GUI 420 is depicted to include a notification 424 indicative of the one or more control links generated by the host user 106a. The notification 424 is further associated with an acceptance option 422. The acceptance option 422 allows the user 102ato accept the notification 424, indicating the one or more control links to join the interactive session of the host user 106a. The one or more control links (or the notification 424) may be associated with the predefined time (e.g., 30 seconds). The system 200 allows the user 102a to select the acceptance option 422 within the predefined time. In case, the user 102a selects the acceptance option 422 within the predefined time, the user 102a is allowed to access the interactive session of the host user 106a. Upon lapse of the predefined time, the system 200 replaces the acceptance option 422 as expired. Additionally, the GUI 420 includes an input field 426 to provide interaction inputs to the host user 106a upon acceptance of the notification 424 to join the interactive session of the host user 106a.

FIG. 4C illustrates an exemplary representation of a graphical user interface (GUI) 430 depicting a control interface of thecontrolling role to interact with the host user 106a, in accordance with an embodiment of the present disclosure. The system 200 establishes the interactive session between the host user 106a and the users 102 upon the acceptance of the notification, such as the notification 424 indicative of the one or more control links, by providing selection inputs in their respective user terminals 104a-104d. The system 200 may render an information section 440 on the GUI 430. The information section 440 may include data related to the at least one stimulation device 110a, the predefined time to control the at least one stimulation device 110a and/or the set of operative components of the stimulation device 110a, and the like.

Additionally, the GUI 430 renders a participants list 432 of the interactive session. The participants list 432 of the interactive session may include a the plurality of participating users, such as the user 102a, the user 102b, the user 102c, and the user 102d of the interactive session, and a host or the creator, such as the host user 106a. Further, the GUI 430 depicts an operational role 434 associated with each of the plurality of participating users among the users 102a-102d and the host user 106a. Herein, the operational role specifies which party (or the host user 106a) is being controlled, the current controlled role is assigned to the host user 106a, the current controlling role (or current controller) is assigned to the user 102a, and the waiting controller (e.g., the users 102b-102d) in the queue to interact with the host user 106a. The current controller and the waiting controller shown in the participants list 432 may interact with the host user 106a based on the set of predetermined rules, as described above. In this scenario, the host user 106a is associated with the controlled state. The user 102a is associated with the control state, indicating the current controller of the host user 106a. The control state enables the user 102a to provide the at least one instruction to operate the at least one stimulation device 110a associated with the host user 106a. Similarly, the users 102b-102d are associated with the waiting state, indicating the waiting controller in the queue. The users 102b-102d with the waiting state are required to wait until the lapse of control duration (e.g., 5 minutes) allocated to the user 102a.

Further, the system 200 renders a control interface 436 in the GUI 430 to allow the users 102 to provide the at least one control instruction for operating the at least one stimulation device 110a associated with the host user 106a. The control interface 436 includes a set of control buttons 440. The set of control buttons 440 includes a control button 440a, a control button 440b, and a control button 440c. For illustration purposes, only three control buttons (i.e., the control buttons 440a-440c) are depicted, there may be any number of control buttons to operate the at least one stimulation device 110a. The set of control buttons 440 is dedicated to provide the at least one control instruction to operate at least one of the at least one stimulation device 110a and the set of operative components associated with the at least one stimulation device 110a. Furthermore, the control interface 436 is associated with a graphical interface 438. The graphical interface 438 renders a control pattern based on the at least one control instruction. In some embodiments, the GUI 430 of the user 102a of the may render a time window indicating a predefined duration. For example, the time window may be rendered as a counter. Herein, the predefined duration corresponds to the operating time in which the user 102a is allowed to operate the at least one stimulation device 110a associated with the host user 106a. For instance, the system 200 may initiate a counter for 5 minutes, and the visual representation of the counter may be rendered in the GUI 430. The visual representation of the counter may be used to a countdown of the remaining time available for controlling, or show the duration for which the user 102a have already been controlling.

FIG. 4D illustrates an exemplary representation of a graphical user interface (GUI) 450 depicting a control interface of the waiting controlling role to interact with the host user 106a, in accordance with an embodiment of the present disclosure. As shown, the GUI 450 is similar to the GUI 430. Herein, the GUI 450 is rendered to the waiting controlling role, for example, the user 102b of the interactive session. The GUI 450 is depicted to include a waiting time indicator 452. The waiting time indicator 452 includes a time window (see, 454). The time window 454 may be set in minutes scale. As shown, the user 102b is required to wait 00:29 minutes to receive access to interact with the host user 106a, or control the stimulation device 110a and/or the associated set of operative components.

FIG. 4E illustrates an exemplary representation of the graphical user interface (GUI) 460 depiciting transmission of a request to reassign the operational roles in the interactive session, in accordance with an embodiment of the present disclosure. The graphical user interface 460 may be rendered to the current host, such as the host user 106a based on providing inputs on the change controller option 408 in the GUI 400. Upon selection of the change controlling role option 408 by the host user 106a, the GUI 460 renders a notification 462 depicting the request to reassign the controlling role and the controlled role. Further, the request (or the notification 462) is transmitted to the users 102 through the interactive platform 118. Upon acceptance of the request by a target user (e.g., the user 102a) among the users 102 using their corresponding user terminals 104a-104d, the GUI 460 is configured to render an acceptance notification (see, 464) to the host user 106a. In this scenario, The system 200 disables the graphical user interface 460 in the user device 104a associated with the host user 106a. The controlling role of the user 102a is assigned as the controlled role and the host user 106a is assigned as the controlling role in the interactive session. Further, the set of predetermined rules associated with the host user 106a is directly applied to the user 102a upon the reassignment of the operational roles in the interactive session. The system 120 switches the graphical user interface 460 of the controlling role and the controller role between the host user 106a and the target user (i.e., the user 102a). Furthermore, one or more operations related to reassigning of the controlled role and the controlling role in the interactive session are described in detail with reference to FIG. 2, therefore they are not reiterated for the sake of brevity.

The system 200 may receive a revocation request from the host user 106a. The revocation request may be configuired to reclaim the an operational role (e.g., the controlled role) in the interactive session. The system 200 disables the graphical user interaface 450 of the controlling role of the host user 106a and the graphical user interaface 460 of the controlled role of the user 102a. Further, the system 200 switches the graphical user interface 450 of the controlling role and the graphical user interface 460 of the controlled role between the host user 106a and the user 102a.

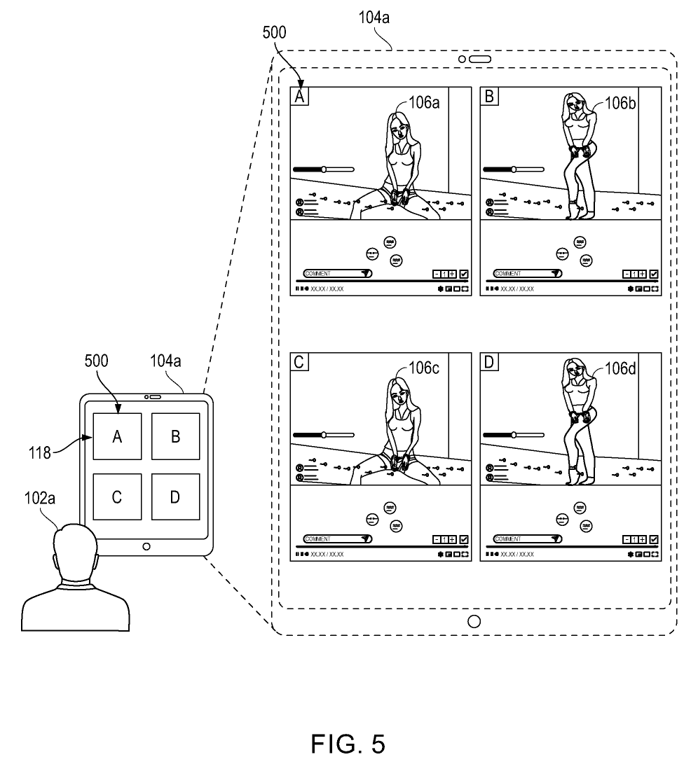

FIG. 5 illustrates an exemplary representation of an overall interactive session 500, in accordance with an embodiment of the present disclosure. Herein, the overall interactive session 500 provides cross-platform compatibility, ensuring that hosts, such as the host users 106 from different platforms to participate in a unified manner, thereby providing the viewers, such as the users 102, the ability to seamlessly switch between different live stream rooms while maintaining control over each connected stimulation device.

As shown, the overall interactive session 500 renders four platforms, such as platform A, platform B, platform C, and platform D. The platform A corresponds to the interactive session of the host user 106a. For example, the platform A may be the interactive platform 118. The interactive session associated with the host user 106a may include at least one stimulation device 110aand the set of operative components of the at least one stimulation device 110a. Similarly, the platforms B, C, and D correspond to the interactive sessions of the host users 106b, 106c, and 106d. The platforms B, C, and D may be hosted and managed by the one or more third-party interactive platforms 122. The interactive sessions created by the host users 106b-106d may include the corresponding at least one stimulation device 110b-110d and the set of operative components of each of the at least one stimulation device 110b-110d.

Further, the system 200 receives a request from the plurality of host users 106 to join the overall interactive session 500. Each host user of the plurality of host users 106 is associated with the interactive session managed by the respective platform (such as platforms A, B, C, and D). The system 200 allows each of the host users 106 to join the overall interactive session 500 based on the receipt of the request. Further, the system 200 assigns a sub interactive session of the one or more sub interactive sessions to each of the host users 106 associated with at least the interactive platform 118 and the one or more third-party interactive platforms 122, within the overall interactive session 500. Accordingly, each sub interactive session of the one or more sub interactive sessions in the overall interactive session 500 corresponds to the platforms A, B, C, and D.

In some embodiments, the system 200 may be configured to maintain a main control link. The main control link is a central hub for the one or more sub interactive sessions. The main control link is configured as a top-level control interface providing access to the plurality of users 102 via the interactive platform 118.

The system 200 may generate a control command for each sub interactive session of the one or more sub interactive sessions (e.g., the platforms A, B, C, and D) within the overall interactive session 500. Specifically, the main control link is interfaced with the control command each sub interactive session of the one or more sub interactive sessions within the overall interactive session 500. The system 200 transmits the control command to the plurality of users 102 using the interactive platform 118. The control command allows a plurality of participating users (e.g., the user 102a, the user 102b, the user 102c, and the user 102d) among the plurality of users 102 to access a corresponding platform among the platforms A-D to interact with a host user of the corresponding platform in the overall interactive session 500. For instance, the platforms A, B, C, and D may include a corresponding first control command, second control command, third control command, and fourth control command to provide access to the platform A, the platform B, the platform C, and the platform D. In this scenario, the user 102a may access the first control command to interact with the host user 106a of the platform A (as shown in FIG. 5). Upon accessing the platform A, the user 102a is configured to provide the at least one control instruction to control the at least one stimulation device 110a, the set of operative components of the at least one stimulation device 110a, or a combination thereof. Further, the user 102a may seamlessly switch between the platforms A-D, to interact with the host users 106a-106d.

Similarly, the users 102b-102d may utilize any of the first, second, third, and fourth control commands to interact with the host users 106a-106d in the corresponding platforms A-D, simultaneously or independently. In an embodiment, each of the users 102a-102d may interact with the corresponding host users 106a-106d performing in the respective platforms A-D based on turn-based manner, sequentially, or on the priority to entering the sub-interactive session of each of the host users 106a-106d. For example, the users 102a and 102b may enter the platform A, including the host user 106a. In this scenario, the system 200 determines a timestamp of accessing the platform A (or joining the platform A) of each of the users 102a and 102b. The user 102a may enter the platform A at 00:30 minutes, and the user 102b may enter the platform B at 00:45 minutes. The system 200 prioritizes the user 102a over the user 102b, and allows the user 102a to interact with the host user 106a in the platform A. It should be noted that, interaction by the user 102a may include exchange of messages, information, comments, the at least one control instruction with the host user 106a. Further, the system 200 may define a control duration for the user 102a for interacting with the host user 106a. Upon expiry of the control duration assigned to the user 102a, the system 200 transmits the control authority to the subsequent user (such as the user 102b) in the queue of the platform A based on the time stamp.

In one embodiment, the overall interactive session 500 may be executed in a virtualized environment. In this scenario, the system 200 allows the users 102 (or viewers) who satisfy a preset condition to join the overall interactive session 500. For example, the preset condition may be a subscription plan. The user 102a, unlocking the subscription plan or satisfying the preset condition, may have direct access to the overall interactive session 500. The system 200 enables the direct control over the respective host users in the overall interactive session 500 based on the preset condition. The user 102a may access the overall interactive session 500 to interact with the host users 106 of the platforms A, B, C, and D in the overall interactive session 500.

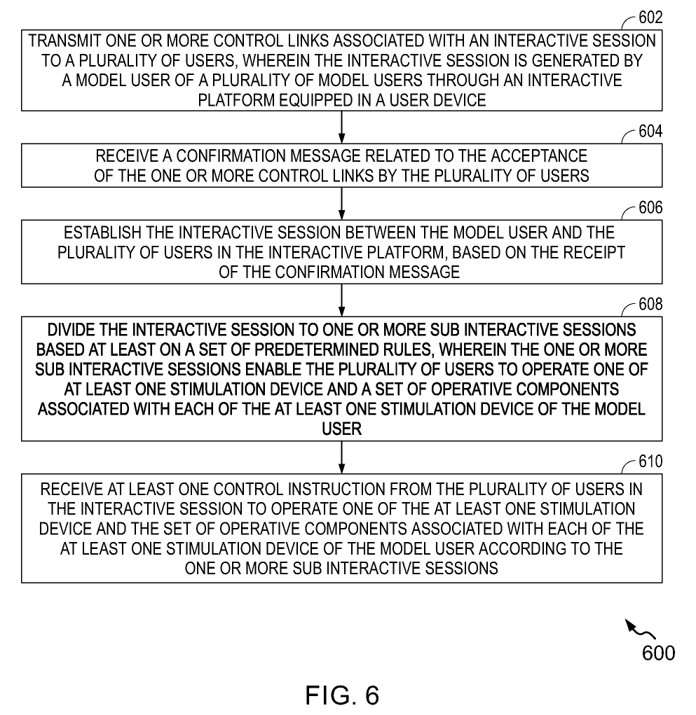

FIG. 6 illustrates a flow diagram of a computer-implemented method 600 for providing the interactive platform 118 to manage the interactive session between the host user 106a and the users 102, in accordance with an embodiment of the present disclosure. The method 600 depicted in the flow diagram may be executed by, for example, the system 200 or the system 120. Operations of the flow diagram of the method 600, and combinations of the operations in the flow diagram of the method 600, may be implemented by, for example, hardware, firmware, a processor, circuitry, and/or a different device associated with the execution of software that includes one or more computer program instructions. It is noted that the operations of the method 600 can be described and/or practiced by using a system other than the system 200. The method 600 starts at operation 602.

At operation 602, the method 600 includes establishing, by the system 200, the interactive session between the plurality of users 102 in the interactive platform 118..

At operation 604, the method 600 includes creating, by the system 200, the role pool associated with the interactive session. The role pool includes the at least one controlling role and the one or more controlled roles. The role pool is created in the interactive session by assigning the at least one controlling role and the one or more controlled roles to the corresponding user of the plurality of users 102.

At operation 606, the method 600 includes dividing, by the system 200, the interactive session into one or more sub interactive sessions based at least on the set of predetermined rules. The one or more sub interactive sessions enable the one or more controlling roles to operate one of the at least one stimulation device 110a and the set of operative components associated with each of the at least one stimulation device 110a of the one or more controlled roles.

At operation 608, the method 600 includes receiving, by the system 200, the at least one control instruction from the at least one controlling role in the interactive session to operate one of the at least one stimulation device 110a and the set of operative components associated with each of the at least one stimulation device 110a of the one or more controlled roles according to the one or more sub interactive sessions.

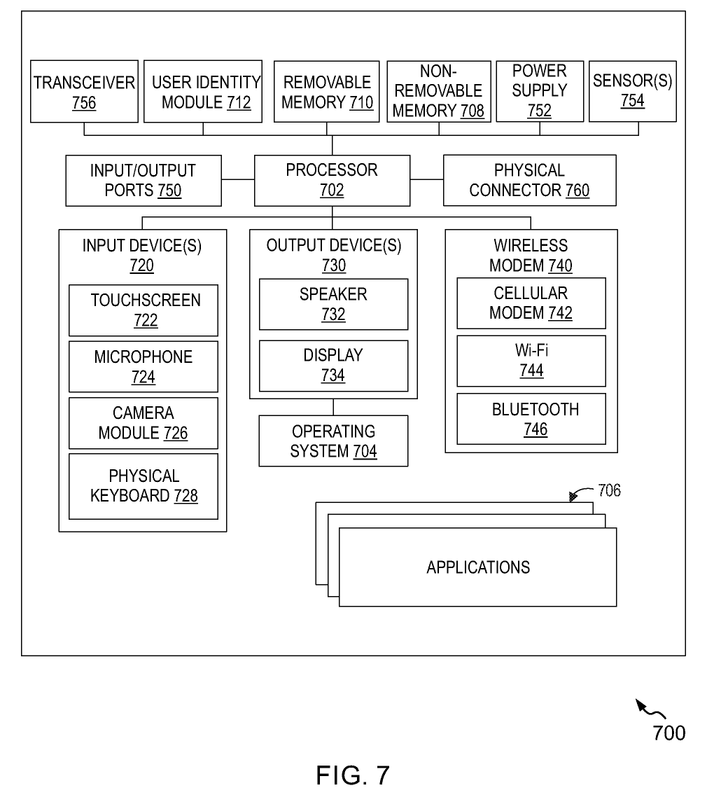

FIG. 7 is a simplified block diagram of an electronic device 700 capable of implementing various embodiments of the present disclosure. For example, the electronic device 700 may correspond to the user terminals 104a-104d, and the user devices 108a-108d of FIG. 1. The electronic device 700 is depicted to include one or more applications 706. For example, the one or more applications 706 may include the interactive platform 118 and the one or more third-party interactive platforms 122 of FIG. 1. The one or more applications 706 installed on the electronic device 700 are capable of communicating with a server (i.e., the system 200 or the system 120) to render an interactive platform.

It should be understood that the electronic device 700 as illustrated and hereinafter described is merely illustrative of one type of device and should not be taken to limit the scope of the embodiments. As such, it should be appreciated that at least some of the components described below in connection with the electronic device 700 may be optional and thus in an embodiment may include more, less, or different components than those described in connection with the embodiment of the FIG. 7. As such, among other examples, the electronic device 700 could be any mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the electronic device 700 and supports one or more operations of the application (see, the applications 706) that implements one or more of the innovative features described herein. In addition, the applications 706 may include common mobile computing applications (e.g., telephony applications, email applications, calendars, contact managers, web browsers, messaging applications) or any other computing application.

The illustrated electronic device 700 includes one or more memory components, for example, a non-removable memory 708 and/or removable memory 710. The non-removable memory 708 and/or the removable memory 710 may be collectively known as a database in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704 and the applications 706. The electronic device 700 may further include a user identity module (UIM) 712. The UIM 712 may be a memory device having a processor built in. The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in the form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 700 can support one or more input devices 720 and one or more output devices 730. Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited to, a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device, or a local wireless data network or router, and/or a Bluetooth-compatible modem 746. The wireless modem 740 is typically configured for communication with one or more cellular networks, such as a GSM network for data and voice communications within a single cellular network, between cellular networks, or between the electronic device 700 and a public switched telephone network (PSTN).

The electronic device 700 can further include one or more input/output ports 750, a power supply 772, one or more sensors 774 for example, an accelerometer, a gyroscope, a compass, or an infrared proximity sensor for detecting the orientation or motion of the electronic device 700 and biometric sensors for scanning biometric identity of an authorized user, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

The disclosed method with reference to FIG. 6, or one or more operations of the system 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or Digital Signal Processor (DSP) circuitry).

Particularly, the system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
establishing, by a system, an interactive session between a plurality of users in an interactive platform, wherein the interactive session is associated with at least one controlling role and one or more controlled roles, the one or more controlled roles being associated with at least one stimulation device having a set of operative components;
assigning, by the system, the at least one controlling role and the one or more controlled roles to corresponding users of the plurality of users;
dividing, by the system, the interactive session into a plurality of sub interactive sessions based on the at least one stimulation device, the set of operative components associated with the one or more controlled roles, or a combination thereof, wherein each sub interactive session enables a corresponding controlling role of the at least one controlling role to operate a corresponding stimulation device of the one or more controlled roles, a corresponding operative component of the set of operative components associated with the corresponding stimulation device of the one or more controlled roles, or a combination thereof;
receiving, by the system, at least one control instruction from the at least one controlling role in the interactive session to operate at least one of the corresponding stimulation device or the corresponding operative component according to the plurality of sub interactive sessions.

2. The computer-implemented method as claimed in claim 1, wherein each sub interactive session is scoped to the corresponding controlling role, such that a controlling role scoped to one sub interactive session is precluded from operating an operative component scoped to another controlling role.

3. The computer-implemented method as claimed in claim 1, further comprising:
establishing, by the system, a connection between the controlled role and the at least one stimulation device, the set of operative components, or a combination thereof;
generating, by the system, one or more control links based on the corresponding stimulation device of the at least one stimulation device, the corresponding operative component of the set of operative components associated with the corresponding stimulation device, or a combination thereof,
wherein one or more control links are corresponding to the plurality of sub interactive sessions.

4. The computer-implemented method as claimed in claim 3, further comprising:
receiving, by the system, the one or more control links from a terminal device of the controlled role of the one or more controlled roles;
wherein the at least one control instruction is routed to the corresponding stimulation device, the corresponding operative component, or a combination thereof, via the control link of the one or more control links corresponding to the sub interactive session scoped to the controlling role issuing the at least one control instruction.

5. The computer-implemented method as claimed in claim 1, further comprising:
assigning, by the system, a controlled role of the one or more controlled roles to a host user of a plurality of host users, wherein the host user initiates the establishment of the interactive session; and
assigning, by the system, a controlling role of the at least one controlling role to at least one participating user of the plurality of users, wherein the at least one participating user accesses the interactive session.

6. The computer-implemented method as claimed in claim 5, further comprising:
rendering, by the system, a graphical user interface (GUI) corresponding to the at least one controlling role and the one or more controlled roles via the interactive platform, wherein the graphical user interface (GUI) corresponding to the at least one controlling role and the one or more controlled roles comprises a corresponding interaction state and corresponding control elements;
receiving, by the system, a request from the host user to reassign the controlled role of the host user, wherein the controlled role corresponds to the host user among the plurality of host users performing sexual activities using the at least one stimulation device, the set of operative components, or a combination thereof;
transmitting, by the system, the request related to reassigning the controlled role to a target user among the plurality of users of the interactive session;
receiving, by the system, an approval message indicating the acceptance of the request by the target participating user;
switching, by the system, the graphical user interface of the controlling role for the target participating user to the graphical user interface of the controlled role in the interactive session; and
disabling, by the system, the graphical user interface of the controlled role for the host user.

7. The computer-implemented method as claimed in claim 6, wherein switching of the controlling role for the target participating user to the graphical user interface of the controlled role further comprises:
determining, by the system, whether the approval message indicating the acceptance of the request is received from the user within a preset time window defined for the request;
in response to receipt of the approval message within the preset time window, determining, by the system, a connectivity status between the stimulation device of the user and a user terminal of the user, the connectivity status being one of a connected state and a disconnected state; and
in response to determining, by the system, the connectivity status being the connected state, switching, by the system, the graphical user interface of the controlling role for the target participating user to the graphical user interface of the controlled role in the interactive session.

8. The computer-implemented method as claimed in claim 6, further comprising:
receiving, by the system, a revocation request from the host user to reclaim the controlled role in the interactive session;
disabling, by the system, the graphical user interface of the controlled role for the target participating user in the interactive session; and
switching, by the system, the graphical user interface of the controlling role for the host user to the graphical user interface of the controlled role in the interactive session.

9. The computer-implemented method as claimed in claim 1, wherein each sub-interactive session corresponds an internal control mode, and the control mode of each sub-interactive session is generated according to a set of predetermined rules.

10. The computer-implemented method as claimed in claim 9, wherein the the set of predetermined rules includes at least one of: an amount of tokens provided by the controlling role, a configuration setting defined by the controlled role, predefined sequential order and a user-account level of the controlling role.

11. The computer-implemented method as claimed in claim 1, further comprising:
assigning, by the system, a first identifier and a second identifier for the at least one stimulation device and the set of operative components of the at least one stimulation device, respectively; and
generating, by the system, the one or more control links by appending the first identifier and the second identifier of the corresponding at least one stimulation device and the set of operative components of the at least one stimulation device.

12. The computer-implemented method as claimed in claim 1, wherein the at least one stimulation device is associated with the set of operative components, the set of operative components comprising at least one of actuators, temperature regulators, liquid dispensing components, fragrance emitting components, and audio devices.

13. The computer-implemented method as claimed in claim 1, comprising:
receiving, via the system, a request from a plurality of host users to join an overall interactive session, wherein each host user of the plurality of host users is associated with a respective interactive session being managed by at least the interactive platform and one or more third-party interactive platforms communicably coupled to the system;
assigning, via the system, a sub interactive session of the plurality of sub interactive sessions to each host user associated with at least the interactive platform and the one or more third-party interactive platforms, within the overall interactive session;
generating, via the system, a control command for each sub interactive session of the plurality of sub interactive sessions within the overall interactive session; and
transmitting, via the system, the control command of each of the plurality of sub interactive sessions to the plurality of host users, thereby allowing a plurality of participating users among the plurality of users to control at least one of the at least one stimulation device and the set of operative components of the at least one stimulation device of a corresponding host user of the plurality of host users in the corresponding sub interactive session within the overall interactive session.

14. The computer-implemented method as claimed in claim 13, further comprising:
enabling, by the system, the plurality of participating users to access the overall interactive session comprising the plurality of sub interactive sessions associated with the one or more controlled roles based on a set of preset conditions.

15. A system, comprising:
a communication interface;
a memory storing executable instructions; and
a processor operatively coupled with the communication interface and the memory, the processor configured to execute the executable instructions to cause the system to at least:
establish an interactive session between a plurality of users in an interactive platform, wherein the interactive session is associated with at least one controlling role and one or more controlled roles, the one or more controlled roles being associated with at least one stimulation device having a set of operative components;
assign the at least one controlling role and the one or more controlled roles to corresponding users of the plurality of users;
divide the interactive session into a plurality of sub interactive sessions based on the at least one stimulation device, the set of operative components associated with the one or more controlled roles, or a combination thereof, wherein each sub interactive session enables a corresponding controlling role of the at least one controlling role to operate a corresponding stimulation device of the one or more controlled roles, a corresponding operative component of the set of operative components associated with the corresponding stimulation device of the one or more controlled roles, or a combination thereof;
receive at least one control instruction from the at least one controlling role in the interactive session to operate at least one of the corresponding stimulation device or the corresponding operative component according to the plurality of sub interactive sessions.

16. The system as claimed in claim 15, wherein each sub interactive session is scoped to the corresponding controlling role, such that a controlling role scoped to one sub interactive session is precluded from operating an operative component scoped to another controlling role.

17. The system as claimed in claim 15, further comprising:
establish a connection between the controlled role and the at least one stimulation device, the set of operative components, or a combination thereof;
generate one or more control links based on the corresponding stimulation device of the at least one stimulation device, the corresponding operative component of the set of operative components associated with the corresponding stimulation device, or a combination thereof,
wherein one or more control links are corresponding to the plurality of sub interactive sessions.

18. The system as claimed in claim 15, further comprising:
assign a controlled role of the one or more controlled roles to a host user of a plurality of host users, wherein the host user initiates the establishment of the interactive session; and
assign a controlling role of the at least one controlling role to at least one participating user of the plurality of users, wherein the at least one participating user accesses the interactive session.

19. The system as claimed in claim 18, further comprising:
render a graphical user interface (GUI) corresponding to the at least one controlling role and the one or more controlled roles via the interactive platform, wherein the graphical user interface (GUI) corresponding to the at least one controlling role and the one or more controlled roles comprises a corresponding interaction state and corresponding control elements;
receive a request from the host user to reassign the controlled role of the host user, wherein the controlled role corresponds to the host user among the plurality of host users performing sexual activities using the at least one stimulation device, the set of operative components, or a combination thereof;
transmit the request related to reassigning the controlled role to a target user among the plurality of users of the interactive session;
receive an approval message indicating the acceptance of the request by the target participating user;
switch the graphical user interface of the controlling role for the target participating user to the graphical user interface of the controlled role in the interactive session; and
disable the graphical user interface of the controlled role for the host user.

20. A non-transitory computer-readable medium storing executable instructions that, when executed by one or more processors, cause the one or more processors to at least:
establish an interactive session between a plurality of users in an interactive platform, wherein the interactive session is associated with at least one controlling role and one or more controlled roles, the one or more controlled roles being associated with at least one stimulation device having a set of operative components;
assign the at least one controlling role and the one or more controlled roles to corresponding users of the plurality of users;
divide the interactive session into a plurality of sub interactive sessions based on the at least one stimulation device, the set of operative components associated with the one or more controlled roles, or a combination thereof, wherein each sub interactive session enables a corresponding controlling role of the at least one controlling role to operate a corresponding stimulation device of the one or more controlled roles, a corresponding operative component of the set of operative components associated with the corresponding stimulation device of the one or more controlled roles, or a combination thereof;
receive at least one control instruction from the at least one controlling role in the interactive session to operate at least one of the corresponding stimulation device or the corresponding operative component according to the plurality of sub interactive sessions.
